(19) United States
(12) Patent Application Publication
(10) Pub. No.: US 2011/0022687 A1
(43) Pub. Date: Jan. 27, 2011

(54) SYSTEM AND METHOD FOR AUTOMATED, PEER-BASED CONFIGURATION OF NETWORK SERVICES

(76) Inventor: Sheng W. LEE, Irvine, CA (US)

Correspondence Address: SoCAL IP LAW GROUP LLP, 310 N. WESTLAKE BLVD. STE 120, WESTLAKE VILLAGE, CA, 91362, US

(21) Appl. No.: 12/508,049

(22) Filed: Jul. 23, 2009

(51) Int. Cl. G06F 15/177

(52) U.S. Cl. 709/220

(57) ABSTRACT

The subject application is directed to a system and method for automated, peer-based configuration of network services. An initial query is broadcast in a constrained communication protocol over a network via a network interface in accordance with a data peripheral including a processor operable in conjunction with associated memory. A reply, inclusive of identification data for each peer device, is received via the network interface in the constrained communication protocol. The acceptability of a peer device is then determined based on the received identification data. Network communication parameters are extracted from one of the peer devices in accordance with the determination. The extracted network communication parameters are stored in the memory, and the network interface is configured in accordance with the stored network communication parameters, so that the interface, configured with the network communication parameters, is operable in extended network communication protocol relative to the constrained communication protocol.

### BACKGROUND OF THE INVENTION

The subject application is directed generally to configuration of network devices. The application is particularly applicable to automated configuration of newly installed network devices by replicating network settings used by one or more peered devices previously installed on a network.

Data networks are in widespread use to allow for sharing of data between devices, such as computers, as well as for communication with networked peripherals, such as copiers, printers, scanners, facsimile machines or multifunction peripherals. There are many different communication protocols in used by networked data devices. It is often difficult or time consuming for network administrators to install and configure new network devices so that they may effectively communicate with varied devices installed on a commonly accessible data network.

### SUMMARY OF THE INVENTION

In accordance with one embodiment of the subject application, there is provided a system and method for automated, peer-based configuration of network services. An initial query is broadcast in a constrained communication protocol over a network via a network interface in accordance with a data peripheral including a processor operable in conjunction with associated memory. A reply is received via the network interface in the constrained communication protocol from at least one networked peer device, which reply includes device identification data for each peer device. The acceptability of a peer device is then determined in accordance with the received device identification data. Network communication parameters are then extracted from at least one of the networked peer devices in accordance with the determination. The extracted network communication parameters are stored in the memory, and the network interface is configured in accordance with the stored network communication parameters, so that the interface, configured with the network communication parameters, is operable in an extended network communication protocol relative to the constrained communication protocol.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for automated, peer-based configuration of network services according to one embodiment of the subject application;

FIG. 2 is a block diagram illustrating device hardware for use in the system for automated, peer-based configuration of network services according to one embodiment of the subject application;

FIG. 3 is a functional diagram illustrating the device for use in the system for automated, peer-based configuration of network services according to one embodiment of the subject application;

FIG. 4 is a block diagram illustrating controller hardware for use in the system for automated, peer-based configuration of network services according to one embodiment of the subject application;

FIG. 5 is a functional diagram illustrating the controller for use in the system for automated, peer-based configuration of network services according to one embodiment of the subject application;

FIG. 6 is a functional diagram illustrating a workstation for use in the system for automated, peer-based configuration of network services according to one embodiment of the subject application;

FIG. 7 is a block diagram illustrating the system for automated, peer-based configuration of network services according to one embodiment of the subject application;

FIG. 8 is a functional diagram illustrating the system for automated, peer-based configuration of network services according to one embodiment of the subject application;

FIG. 9 is a flowchart illustrating a method for automated, peer-based configuration of network services according to one embodiment of the subject application; and

FIG. 10 is a flowchart illustrating a method for automated, peer-based configuration of network services according to one embodiment of the subject application.

### DETAILED DESCRIPTION OF THE PREFERRED EMBODIMENT

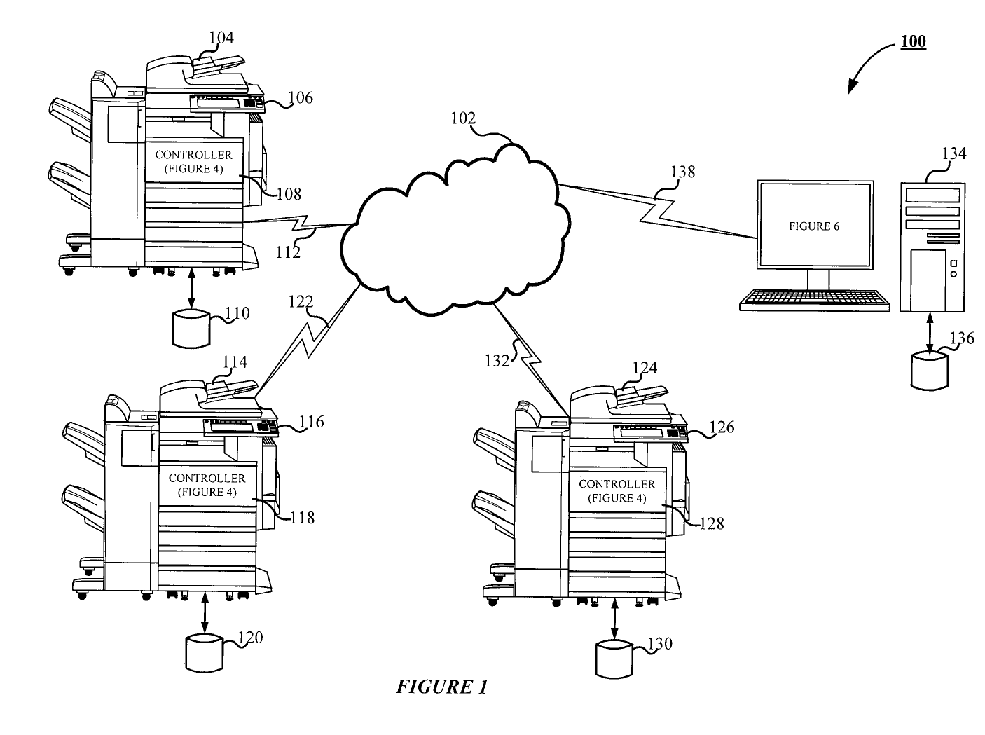

The subject application is directed to a system and method for configuring a networked device. In particular, the subject application is directed to a system and method for automatically configuring newly installed network devices by replicating network settings used by one or more peer devices previously installed on a network. More particularly, the subject application is directed to a system and method that is applicable to automated, peer-based configuration of network services. It will become apparent to those skilled in the art that the system and method described herein are suitably adapted to a plurality of varying electronic fields employing automated configuration, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for automated, peer-based configuration of network services in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also one or more document processing devices, depicted in FIG. 1 as the document processing devices 104, 114, and 124. As shown in FIG. 1, the document processing devices 104, 114, and 124 are illustrated as multifunction peripheral devices, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing devices 104, 114, and 124 are suitably adapted to provide remote document rendering services to external or network devices. According to one embodiment of the subject application, the document processing devices 104, 114, and 124 include hardware, software, and any suitable combination thereof, configured to interact with an associated user, a networked device, or the like. Preferably, the document processing devices 104, 114, and 124 are capable of communicating electronic documents to and from each other in accordance with user provided instructions, transferring electronic documents amongst each other based upon output capabilities, locations, or the like.

According to one embodiment of the subject application, the document processing devices 104, 114, and 124 are suitably equipped to receive a plurality of portable storage media, including, without limitation, Firewire drive, USB drive, SD, MMC, XD, Compact Flash, Memory Stick, and the like. In the preferred embodiment of the subject application, the document processing devices 104, 114, and 124 further include associated user interfaces 106, 116, and 126, such as a touch-screen, LCD display, touch-panel, alpha-numeric keypad, or the like, via which an associated user is able to interact directly with the document processing devices 104, 114, and 124. In accordance with the preferred embodiment of the subject application, the user interfaces 106, 116, and 126 are advantageously used to communicate information to associated users and receive selections from such associated users.

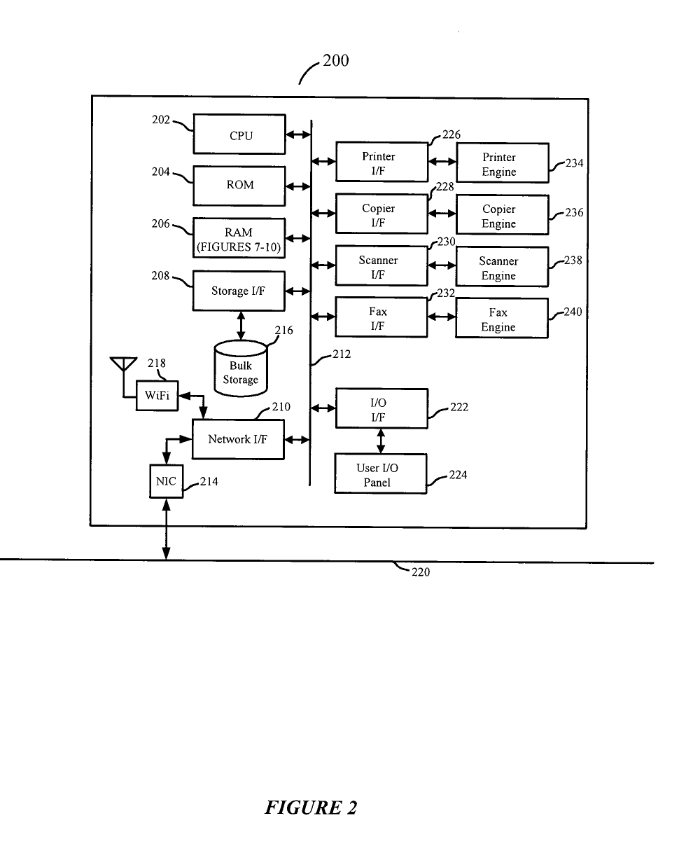

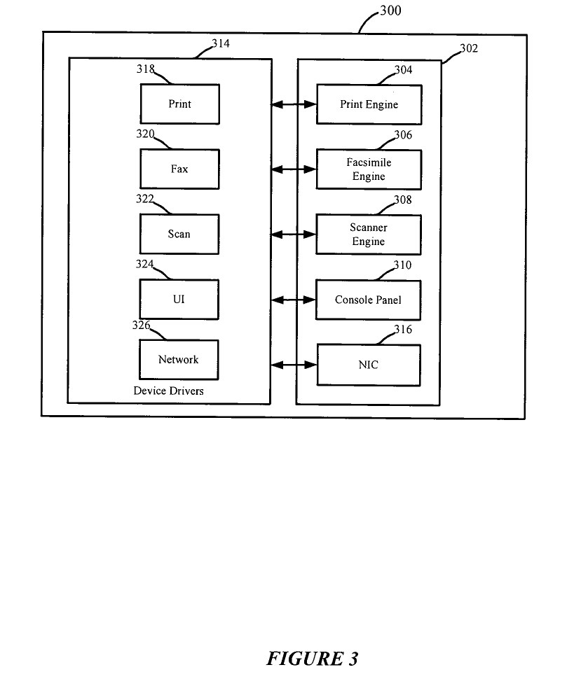

The skilled artisan will appreciate that the user interfaces 106, 116, and 126 comprise various components, suitably adapted to present data to associated users, as are known in the art. In accordance with one embodiment of the subject application, the user interfaces 106, 116, and 126 comprise a display, suitably adapted to display one or more graphical elements, text data, images, or the like, to an associated user, receive input from the associated user, and communicate the same to a backend component, such as controllers 108, 118, and 128, as explained in greater detail below. Preferably, the document processing devices 104, 114, and 124 are communicatively coupled to the computer network 102 via suitable communications links 112, 122, and 132. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing devices 104, 114, and 124 will be better understood in conjunction with the block diagrams illustrated in FIGS. 2 and 3, explained in greater detail below.

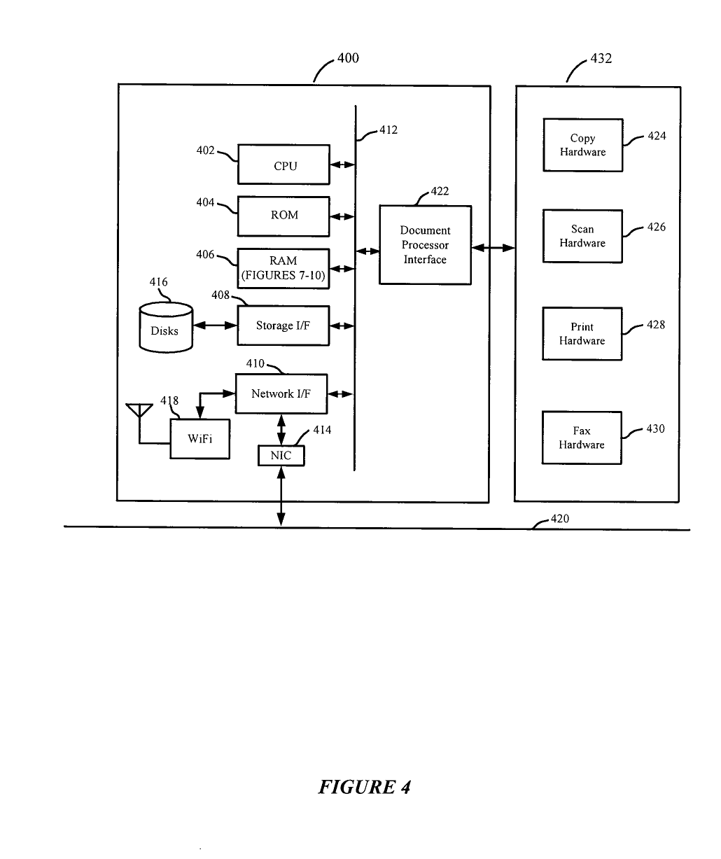

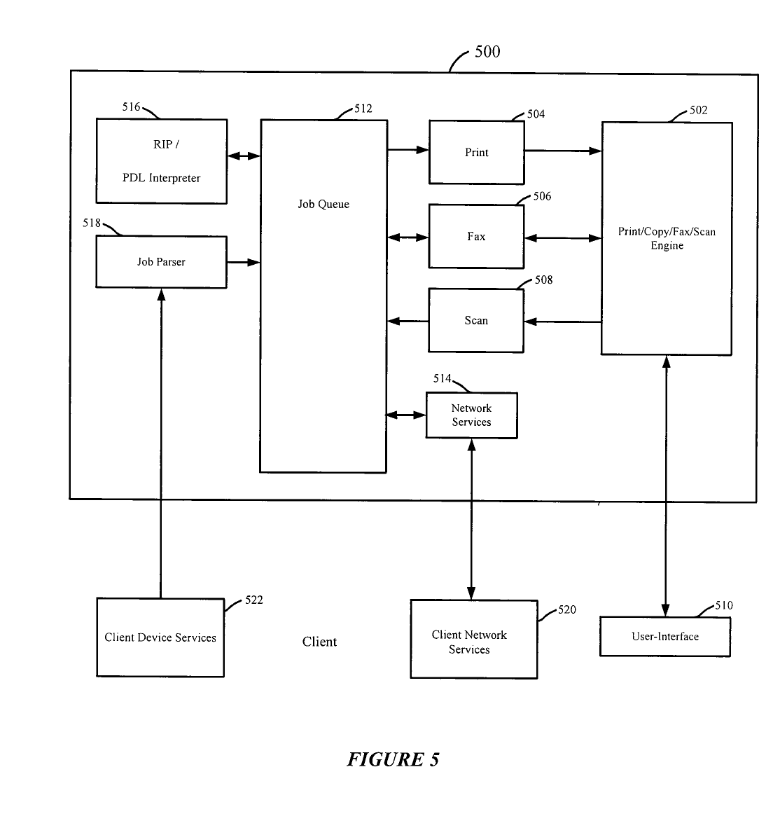

In accordance with one embodiment of the subject application, the document processing devices 104, 114, and 124 further incorporate a backend component, designated as the controllers 108, 118, and 128, suitably adapted to facilitate the operations of their respective document processing devices 104, 114, and 124, as will be understood by those skilled in the art. Preferably, the controllers 108, 118, and 128 are embodied as hardware, software, or any suitable combination thereof, configured to control the operations of the associated document processing devices 104, 114, and 124, facilitate the display of images via the user interfaces 106, 116, and 126, direct the manipulation of electronic image data, maintain the security of applications, user information, data, and the like. For purposes of explanation, the controllers 108, 118, and 128 are used to refer to any myriad of components associated with the document processing devices 104, 114, and 124, including hardware, software, or combinations thereof, functioning to perform, cause to be performed, control, or otherwise direct the methodologies described hereinafter. It will be understood by those skilled in the art that the methodologies described with respect to the controllers 108, 118, and 128 are capable of being performed by any general purpose computing system, known in the art, and thus the controllers 108, 118, and 128 are representative of such a general computing device and is intended as such when used hereinafter. Furthermore, the use of the controllers 108, 118, and 128 hereinafter is for the example embodiment only, and other embodiments, which will be apparent to one skilled in the art, are capable of employing the system and method for automated, peer-based configuration of network services of the subject application. The functioning of the controllers 108, 118, and 128 will better be understood in conjunction with the block diagrams illustrated in FIGS. 4 and 5, explained in greater detail below.

Communicatively coupled to the document processing devices 104, 114, and 124 are data storage devices 110, 120, and 130. In accordance with the preferred embodiment of the subject application, the data storage devices 110, 120, and 130 are any mass storage device known in the art including, for example and without limitation, magnetic storage drives, a hard disk drive, optical storage devices, flash memory devices, or any suitable combination thereof. In the preferred embodiment, the data storage devices 110, 120, and 130 are suitably adapted to store security levels, security software, document data, image data, electronic database data, or the like. It will be appreciated by those skilled in the art that while illustrated in FIG. 1 as being a separate component of the system 100, the data storage devices 110, 120, and 130 are capable of being implemented as internal storage components of the document processing devices 104, 114, and 124, components of the controllers 108, 118, and 128, or the like, such as, for example and without limitation, an internal hard disk drive, or the like.

Also depicted in FIG. 1 is a computer workstation 134 in data communication with the computer network 102 via a communications link 138. It will be appreciated by those skilled in the art that the workstation 134 is shown in FIG. 1 as a workstation computer for illustration purposes only. As will be understood by those skilled in the art, the workstation 134 is representative of any personal computing device known in the art including, for example and without limitation, a laptop computer, a personal computer, a personal data assistant, a web-enabled cellular telephone, a smart phone, a proprietary network device, or other web-enabled electronic device. According to one embodiment of the subject application, the workstation 134 further includes software, hardware, or a suitable combination thereof configured to interact with the document processing devices 104, 114, and 124, or the like. In one embodiment of the subject application, the workstation 134 includes one or more drivers suitably configured to interact with the document processing devices 104, 114, and 124, prepare electronic documents for output thereby, and the like, as will be understood by those skilled in the art.

The communications link 138 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the workstation 134 is suitably adapted to provide document data, job data, user interface data, image data, monitor document processing jobs, employ thin-client interfaces, generate display data, generate output data, or the like, with respect to the document processing devices 104, 114, or 124, or any other similar device coupled to the computer network 102.

Communicatively coupled to the workstation 134 is the data storage device 136. According to the foregoing example embodiment, the data storage device 136 is any mass storage device, or plurality of such devices, known in the art including, for example and without limitation, magnetic storage drives, a hard disk drive, optical storage devices, flash memory devices, or any suitable combination thereof. In such an embodiment, the data storage device 136 is suitably adapted to store electronic document data, document processing device identification data, document processing device drivers, and the like. It will be appreciated by those skilled in the art that while illustrated in FIG. 1 as being a separate component of the system 100, the data storage device 136 is capable of being implemented as an internal storage component of the workstation 134, or the like, such as, for example and without limitation, an internal hard disk drive, or the like.

Turning now to FIG. 2, illustrated is a representative architecture of a suitable device 200, shown in FIG. 1 as the document processing devices 104, 114, and 124, on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by the bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, depicted in FIG. 1 as the document processing devices 104, 114, and 124, for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controllers 108, 118, and 128, on which operations of the subject system 100 are completed. The skilled artisan will understand that the controller 400 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4, (shown in FIG. 1 as the controllers 108, 118, and 128) as an intelligent subsystem associated with a document processing device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that perform one or more of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

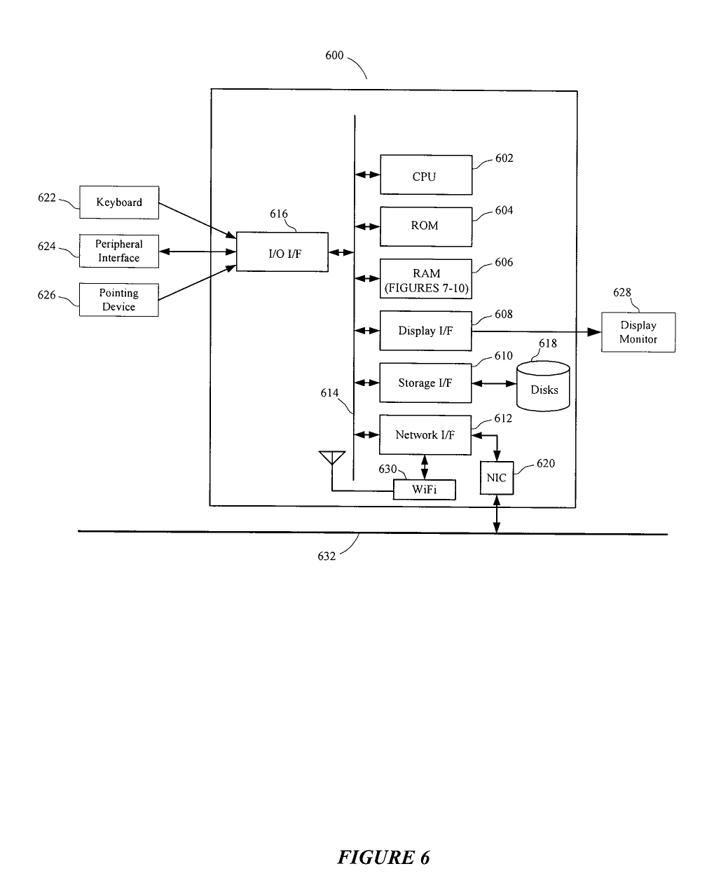

Turning now to FIG. 6, illustrated is a hardware diagram of a suitable workstation 600, shown as the computer workstation 134, for use in connection with the subject system. A suitable workstation includes a processor unit 602 which is advantageously placed in data communication with read only memory 604, suitably non-volatile read only memory, volatile read only memory or a combination thereof, random access memory 606, display interface 608, storage interface 610, and network interface 612. In a preferred embodiment, interface to the foregoing modules is suitably accomplished via a bus 614.

The read only memory 604 suitably includes firmware, such as static data or fixed instructions, such as BIOS, system functions, configuration data, and other routines used for operation of the workstation 600 via CPU 602.

The random access memory 606 provides a storage area for data and instructions associated with applications and data handling accomplished by the processor 602.

The display interface 608 receives data or instructions from other components on the bus 614, which data is specific to generating a display to facilitate a user interface. The display interface 608 suitably provides output to a display terminal 628, suitably a video display device such as a monitor, LCD, plasma, or any other suitable visual output device as will be appreciated by one of ordinary skill in the art.

The storage interface 610 suitably provides a mechanism for non-volatile, bulk or long term storage of data or instructions in the workstation 600. The storage interface 610 suitably uses a storage mechanism, such as storage 618, suitably comprised of a disk, tape, CD, DVD, or other relatively higher capacity addressable or serial storage medium.

The network interface 612 suitably communicates to at least one other network interface, shown as network interface 620, such as a network interface card, and wireless network interface 630, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by one of ordinary skill in the art. In the illustration, the network interface 620 is interconnected for data interchange via a physical network 632, suitably comprised of a local area network, wide area network, or a combination thereof.

An input/output interface 616 in data communication with the bus 614 is suitably connected with an input device 622, such as a keyboard or the like. The input/output interface 616 also suitably provides data output to a peripheral interface 624, such as a USB, universal serial bus output, SCSI, Firewire (IEEE 1394) output, or any other interface as may be appropriate for a selected application. Finally, the input/output interface 616 is suitably in data communication with a pointing device interface 626 for connection with devices, such as a mouse, light pen, touch screen, or the like.

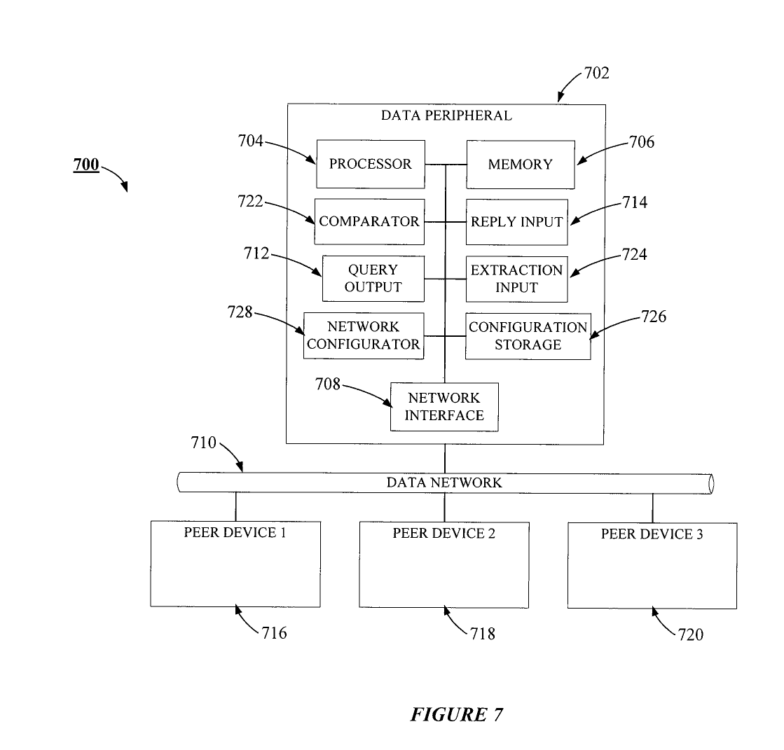

Referring now to FIG. 7, illustrated is a block diagram of a system 700 for automated, peer-based configuration of network services in accordance with one embodiment of the subject application. As shown in FIG. 7, the system 700 includes a data peripheral 702 having a processor 704 and associated memory 706. The system 700 also incorporates a network interface 708 that is configured to communicate data between the data peripheral 702 and a data network 710. The system 700 further includes a query output 712 that is operable via the network interface 708 and configured to initiate an initial device query broadcast over the network 710. According to one embodiment of the subject application, the initial broadcast is formed from a constrained communication protocol.

The system 700 of FIG. 7 further includes a reply input 714 that is operable via the network interface 708, and configured to receive a reply in the constrained communication protocol from at least one networked peer device 716, 718, and 720. Preferably, the reply includes device identification data for each peer device 716, 718, and 720. A comparator 722 is also employed in the system 700 and is operable for determining the acceptability of a peer device 716, 718, or 720 based upon the received device identification data. The system 700 further includes an extraction input 724 operable to extract network communication parameters from at least one of networked peer device 716, 718, or 720 in accordance with an output of the comparator 722. In addition, the system 700 includes a configuration storage 726 that is configured to store extracted network communication parameters in the memory 706.

Furthermore, the system 700 contains a network configurator 728 that is operable to configure the network interface 708 based upon the stored network communication parameters. According to one embodiment of the subject application, the network interface 708 is configured in accordance with the stored network parameters. It will thus be appreciated by those skilled in the art that such configuration of the network interface 708 enables operation in extended network communication protocol relative to the constrained communication protocol.

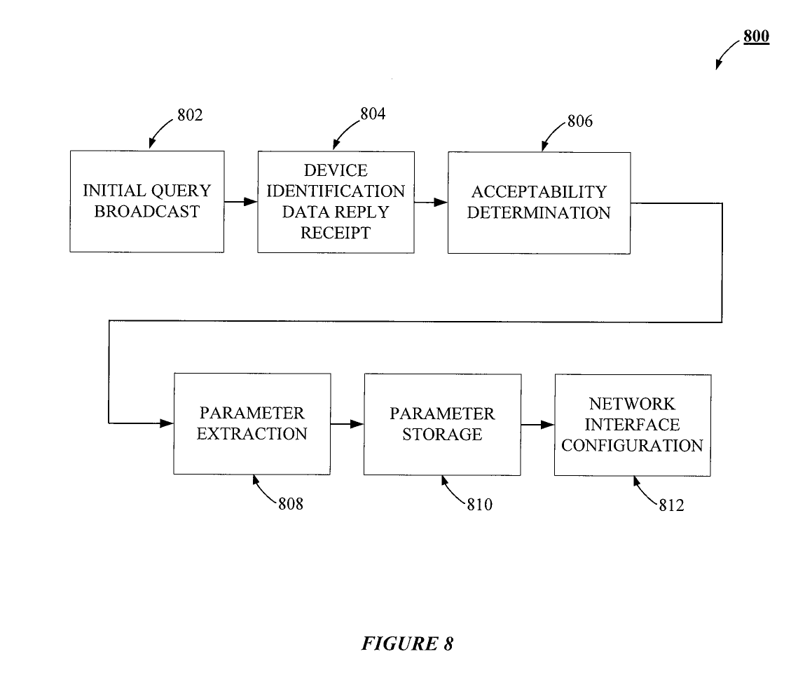

Turning now to FIG. 8, illustrated is a functional diagram of a system 800 for automated, peer-based configuration of network services in accordance with one embodiment of the subject application. As shown in FIG. 8, an initial query broadcast 802 is first performed in a constrained communication protocol over a network via a network interface associated with a data peripheral including a processor operable in conjunction with associated memory. Device identification data reply receipt 804 then occurs via the network interface in the constrained communication protocol from at least one networked peer device. Preferably, the device identification received at 804 includes device identification data for each peer device.

An acceptability determination 806 is then performed so as to determine the acceptability of a peer device in accordance with the received device identification data. Parameter extraction 808 is then performed corresponding to the extraction of network communication parameters from one or more of the networked peer devices based upon the acceptability determination 806. Parameter storage 810 then occurs of the extracted network communication parameters in the memory. Network interface configuration 812 is then performed of the network interface based upon the stored network communication parameters so as to be operable in extended network communication protocol relative to the constrained communication protocol.

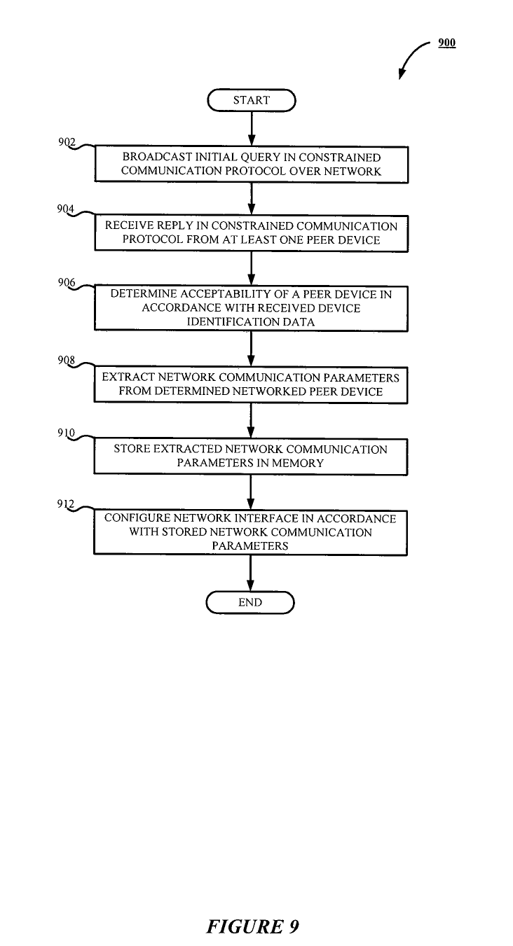

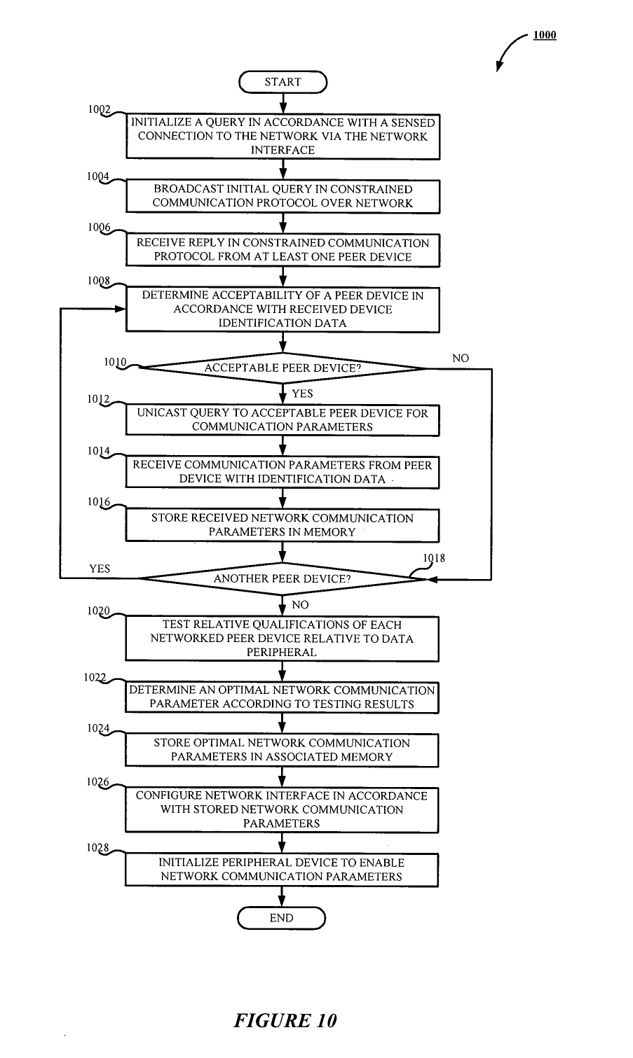

The skilled artisan will appreciate that the subject system 100 and components described above with respect to FIG. 1, FIG. 2, FIG. 3, FIG. 4, FIG. 5, FIG. 6, FIG. 7, and FIG. 8 will be better understood in conjunction with the methodologies described hereinafter with respect to FIG. 9 and FIG. 10. Turning now to FIG. 9, there is shown a flowchart 900 illustrating a method for automated, peer-based configuration of network services in accordance with one embodiment of the subject application. Beginning at step 902, an initial query is broadcast in a constrained communication protocol over a network via a network interface in accordance with a data peripheral including a processor operable in conjunction with associated memory.

At step 904, a reply is received via the network interface in the constrained communication protocol from at least one networked peer device. According to one embodiment of the subject application, the reply includes device identification data for each peer device. The acceptability of a peer device is then determined in accordance with the received device identification data at step 906. Network communication parameters are then extracted from at least one of the networked peer devices at step 908 in accordance with the determination made at step 906.

At step 910, the extracted network communication parameters are stored in the memory. The network interface is then configured at step 912 based on the stored network communication parameters. According to one embodiment of the subject application, the network interface, configured with the network communication parameters, is operable in extended network communication protocol relative to the constrained communication protocol.

Referring now to FIG. 10, there is shown a flowchart 1000 illustrating a method for automated, peer-based configuration of network services in accordance with one embodiment of the subject application. The methodology of FIG. 10 begins at step 1002, whereupon a query is initialized in accordance with a sensed connection to the network 102 by a network interface associated with a first data peripheral device, e.g. the first document processing device 104. It will be appreciated by those skilled in the art that the query includes, but is not limited to, a request for the device types of other data peripheral devices, e.g. the second and third document processing devices 114, 124, and 134. At step 1004, an initial query is broadcast by the controller 108 or other suitable component associated with the document processing device 104 via the network interface (see FIGS. 2-5 above) in a constrained communication protocol over the computer network 102. As will be understood by those skilled in the art, a suitable constrained communication protocol includes, for example and without limitation, simple network management protocol (SNMP), or the like. The skilled artisan will further appreciate that when such a query is broadcast via an SNMP, such that an Object ID in a public management information base (MIB) identifying the devices 114, 124, and 134 is broadcast from the first document processing device 104.

At step 1006, replies are received from each peer device 114 and 124 coupled to the computer network 102 in the constrained communication protocol. Preferably, the replies received from responding peer devices 114 and 124 include suitable device identification data corresponding to each device 114 and 124. In accordance with one embodiment of the subject application, the workstation 134 is capable of being configured as a peer device for each document processing device coupled to the computer network 102 such that the workstation 134 also replies to the broadcast query from the first document processing device 104. The acceptability of a responding peer device 114 or 124 is then determined at step 1008 in accordance with the device identification data from the device 114 or 124 by the controller 108 or other suitable component associated with the document processing device 104.

At step 1010, a determination is made whether the responding peer device 114 or 124 is acceptable to the first document processing device 104 as a peer device. Upon a negative determination, operations proceed to step 1018, whereupon a determination is made whether another potential peer device 114 or 124 has responded to the initial query. When it is determined at step 1018 that at least one additional potential peer device 114 or 124 has responded to the initial query, operations return to step 1008 for a determination as to the acceptability of the responding device 114 or 124. When it is determined at step 1010 that the responding peer device 114 or 124 is acceptable as a peer device, flow proceeds to step 1012. At step 1012, a query is unicast to the peer device 114 or 124 for communication parameters. According to one embodiment of the subject application, the communication parameters include, for example and without limitation, configuration settings, flag settings, network settings, basic functionality settings, and the like.

The communication parameters, along with device identification data, are then received by the first document processing device 104 from the peer device 114 or 124 in response to the unicast query at step 1014. The received network communication parameters are then stored by the first document processing device 104 in associated memory, e.g. the data storage 110, at step 1016. A determination is then made at step 1018 whether any additional potential peer devices 114 or 124 remain for acceptability determinations. Upon a determination at step 1018 that no additional peer devices remain, operations progress to step 1020.

At step 1020, the relative qualifications of each networked acceptable peer device 114 and 124 are tested relative to the first document processing device 104. An optimal network communication parameter is then determined at step 1022 in accordance with the results of the testing performed at step 1020. The optimal network communication parameters are then stored in associated memory, e.g. the data storage 110, at step 1024. The controller 108 or other suitable component associated with the first document processing device 104 then configures the network interface in accordance with stored network communication parameters at step 1026. The first document processing device 104 is then initialized at step 1028 so as to enable operations of the device 104 in extended network communication protocol relative to the constrained communication protocol based upon the configuration made to the network communication parameters. According to one embodiment of the subject application, the extended network communication protocol enables receiving constrained communication protocol queries from at least one additional networked data peripheral, e.g. the document processing devices 114 and 124 received via the network interface by the first document processing device 104.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for automated, peer-based configuration of network services comprising:
a data peripheral including a processor and associated memory;
a network interface configured to communicate data between the data peripheral and a data network;
an output operable via the network interface so as to initiate an initial device query broadcast over the network, the initial broadcast being formed from a constrained communication protocol;
an input operable via the network interface operable to receive a reply in the constrained communication protocol from at least one networked peer device, the reply including device identification data for each peer device;
a comparator operable to determine acceptability of a peer device in accordance with received device identification data;
an input operable to extract network communication parameters from at least one of networked peer device in accordance with an output of the comparator;
a configuration storage operable to store extracted network communication parameters in the memory;
a network configurator operable to configure the network interface in accordance with stored network communication parameters; and
the network interface being configured in accordance with the stored network parameters so as to be operable in extended network communication protocol relative to the constrained communication protocol.

2. The system of claim 1 further comprising a tester operable to test relative qualifications of each of a plurality of networked peer devices relative to the data peripheral, and wherein the comparator is further operable to determine an optimal network communication parameter in accordance with an output of the tester, which optimal network communication parameter is stored in the memory.

3. The system of claim 2 wherein a plurality of optimal network communication parameters are stored from a corresponding plurality of peer devices such that multiple peer devices are used in operation in the extend network communication protocol.

4. The system of claim 3 wherein the extended network communication protocol includes functionality so as to render the data peripheral operable to respond to constrained communication protocol queries from at least one additional networked data peripheral received via the network interface.

5. The system of claim 4 wherein the communication parameters are received from each peer device with the identification data.

6. The system of claim 5 further comprising a query initializer operable in accordance with a sensed connection to the network via the network interface.

7. A method for automated, peer-based configuration of network services comprising the steps of:
broadcasting an initial query in a constrained communication protocol over a network via a network interface associated with a data peripheral including a processor operable in conjunction with associated memory;
receiving, via the network interface, a reply in the constrained communication protocol from at least one networked peer device, the reply including device identification data for each peer device;
determining acceptability of a peer device in accordance with received device identification data;
extracting network communication parameters from at least one of the networked peer devices in accordance with the step of determining;
storing extracted network communication parameters in the memory; and
configuring the network interface in accordance with stored network communication parameters so as to be operable in extended network communication protocol relative to the constrained communication protocol.

8. The method of claim 7 further comprising the step of testing relative qualifications of each of a plurality of networked peer devices relative to the data peripheral, and determining an optimal network communication parameter in accordance with an output of the testing such that the optimal network communication parameter is stored in the memory.

9. The method of claim 8 further comprising the step of storing optimal network communication parameters from a corresponding plurality of peer devices such that multiple peer devices are used in operation in the extend network communication protocol.

10. The method of claim 9 wherein the extended network communication protocol enables receiving constrained communication protocol queries from at least one additional networked data peripheral received via the network interface.

11. The method of claim 10 wherein the communication parameters are received from each peer device with the identification data.

12. The method of claim 11 further comprising the step of initializing a query in accordance with a sensed connection to the network via the network interface.

13. A system for automated, peer-based configuration of network services comprising:
a data peripheral including a processor and associated memory;
a network interface configured to communicate data between the data peripheral and a data network;
means adapted for broadcasting an initial query in a constrained communication protocol over the network via the network interface;
means adapted for receiving, via the network interface, a reply in the constrained communication protocol from at least one networked peer device, the reply including device identification data for each peer device;
means adapted for determining acceptability of a peer device in accordance with received device identification data;
means adapted for extracting network communication parameters from at least one of networked peer device in accordance with the determining;
means adapted for storing extracted network communication parameters in the memory; and
means adapted for configuring the network interface in accordance with stored network communication parameters so as to be operable in extended network communication protocol relative to the constrained communication protocol.

14. The system of claim 13 further comprising means adapted for testing relative qualifications of each of a plurality of networked peer devices relative to the data peripheral, and determining an optimal network communication parameter in accordance with an output of the testing such that the optimal network communication parameter is stored in the memory.

15. The system of claim 14 further comprising means adapted for storing optimal network communication parameters from a corresponding plurality of peer devices such that multiple peer devices are used in operation in the extend network communication protocol.

16. The system of claim 15 wherein the extended network communication protocol enables receiving constrained communication protocol queries from at least one additional networked data peripheral received via the network interface.

17. The system of claim 16 wherein the communication parameters are received from each peer device with the identification data.

18. The system of claim 17 further comprising the step of initializing a query in accordance with a sensed connection to the network via the network interface.
